(19) United States
(12) Patent Application Publication
(10) Pub. No.: US 2010/0147123 A1
(43) Pub. Date: Jun. 17, 2010

(54) Tool emergency brake device

(76) Inventor: Dietmar BAUMANN, Hemmingen (DE)

Correspondence Address: Striker, Striker & Stenby, 103 East Neck Road, Huntington, NY, 11743, US

(21) Appl. No.: 12/580,297

(22) Filed: Oct. 16, 2009

(30) Foreign Application Priority Data
Dec. 16, 2008 (DE) 10 2008 054 694.1

(51) Int. Cl. B23Q 11/06; B26D 7/22; B26D 7/24

(52) U.S. Cl. 83/58; 83/571

(57) ABSTRACT

A tool emergency brake device, in particular for a stationary saw, has a brake unit. The brake unit is designed to brake in a self-energizing manner.

### CROSS-REFERENCE TO A RELATED APPLICATION

The invention described and claimed hereinbelow is also described in German Patent Application DE 10 2008 054 694.1 filed on Dec. 16, 2008. This German Patent Application, whose subject matter is incorporated here by reference, provides the basis for a claim of priority of invention under 35 U.S.C. 119(a)-(d).

### BACKGROUND OF THE INVENTION

The present invention relates to a tool emergency brake device.

More particularly, it relates to a tool emergency brake device, in particular for a stationary saw, which has a brake unit.

Tool emergency brake devices are known in the art. It is believed that the existing tool emergency brake devices can be further improved.

### SUMMARY OF THE INVENTION

Accordingly, it is an object of the present invention to provide a tool emergency brake device, which is a further improvement of the existing tool emergency brake devices.

In accordance with the present invention, the brake unit is designed to brake in a self-energizing manner. A “tool emergency brake device” is intended to mean, in particular, a device that brakes a tool in a situation in which the tool poses a hazard to the operator. In particular, the tool emergency brake device brakes the tool when the operator touches the tool.

The tool emergency brake device preferably includes a computer unit which communicates with at least one sensor. The sensor is designed to detect the presence of a hazard to an operator, and/or contact with the tool by the operator. The computer unit includes an interface to the brake unit, via which the computer unit may trigger brake activation. A “stationary saw” is intended to mean, in particular, to a saw that remains at least partially immobile relative to an environment during a sawing procedure, e.g. a table-top circular saw, a cross saw, a miter saw, a slide miter saw, and/or another type of saw that appears reasonable to a person skilled in the art.

The term “self-energizing” is intended to mean, in particular, that at least a portion of normal braking forces that occur during brake activation is caused by friction braking forces which brake the tool.

Advantageously, the friction braking forces which occur during brake activation remain uninfluenced by the computer unit. A “normal braking force” is intended to mean, in particular, at least a force that acts perpendicularly to a friction surface—the friction of which causes the friction braking force—of the brake unit. A “friction braking force” is intended to mean, in particular, a force that causes the tool to brake, due to friction forces, when braking is activated. The friction braking force is oriented perpendicularly to the normal braking force and is dependent thereon. “Provided” is intended to mean, in particular, specially equipped, designed, and/or programmed. Via the design, according to the present invention, of the tool emergency brake device, the brake unit may attain high dynamics using a simple design, due to its self-energizing action.

In a second embodiment, the present invention is directed to a tool emergency brake device, in particular for a stationary saw, comprising a brake unit, a tool fitting, and a drive unit.

It is provided that the brake unit includes a decoupling device which is designed to decouple the tool fitting and the drive unit in terms of driving action when the emergency brake is activated. A “tool fitting” is intended to mean, in particular, a device that is designed to transfer a torque from a shaft to a tool, and/or to non-rotatably connect the tool to the shaft. A “drive unit” refers, in particular, to a device that is designed to transfer a torque to the shaft. For example, the drive unit may be designed as a gear stage. Advantageously, the torque is generated by an electric motor and/or another type of motor that appears reasonable to a person skilled in the art. A “torque” is also intended to mean, in particular, output that is transmitted via a rotational motion.

A “decoupling device” is intended to mean, in particular, a device that is designed to interrupt a transfer of torque between the tool fitting or a disk element and the drive unit. Advantageously, the decoupling device is designed as a claw clutch, a friction clutch, and/or another type of decoupling device that appears reasonable to a person skilled in the art. The expression “to decouple in terms of driving action” refers, in particular, to the interruption of a force flow and/or power flow between the tool fitting and the drive unit. Using the decoupling device, it is possible to reduce a rotating mass to be braked, and to thereby bring the tool to a standstill within a particularly short period of time.

In a third embodiment, the present invention is directed to a tool emergency brake device, in particular for a stationary saw, comprising a brake unit.

It is provided that the brake unit includes a brake release device which is designed to return the brake unit to a ready-to-use state after braking is carried out. A “brake release device” is intended to mean, in particular, a device that is designed to release a tool-blocking brake of the brake unit after braking is carried out, e.g., by the brake release device moving at least one element of the brake unit. This is advantageously possible by moving a tool, a shaft, and/or by moving an element of the brake unit. The force may be applied using an actuator and/or by an operator. Advantageously, the brake release device exerts a force on a tapered ring via a fastening element.

The expression “to return to a ready-to-use state” is intended to mean, in particular, that, after braking is carried out, the brake release device is used to return the brake unit to a state in which it may perform braking. Preferably, the entire tool is ready to operate after the brake release device is used. Advantageously, the tool emergency brake device only includes parts that are reusable. Particularly advantageously, an operator himself may return the tool to its ready-to-use state using the brake release device, thereby advantageously reducing servicing work and down times of the machine, and reducing the number of components required.

It is furthermore provided that the braking unit includes a wedge actuated brake. A “wedge actuated brake” is intended to mean, in particular, a brake in which the normal braking forces are caused by an inclined plane. As an alternative, other self-energizing brakes that appear reasonable to a person skilled in the art may also be used, e.g., self-energizing brakes that use lever elements and/or hydrodynamic elements. An “inclined plane” refers, in particular, to a plane that, in at least one circumferential direction, moves increasingly closer to a disk element in the direction of rotation of the disk element. It is only necessary for the inclined plane to form a straight line in a direction of the friction braking force. In particular, the inclined plane may be at least partially helical in shape.

Preferably, an acute angle which the inclined plane forms with the disk element is so flat in design that the brake acts in a self-inhibiting manner. Advantageously, the angle is smaller than the arctangent of the coefficient of static friction of the friction surface which includes a brake pad; particularly advantageously, the angle is smaller than the arctangent of the coefficient of sliding friction of the friction surface which includes a brake pad. By using a wedge actuation brake, it is possible to reuse all elements of the tool emergency brake device after braking has been carried out, thereby reducing the number of components to be used.

It is furthermore provided that the brake unit includes a shaft which supports normal braking forces that occur during brake activation. “Support” is intended to mean, in particular, that the shaft induces forces that counteract the normal braking forces. In particular, the shaft may have a several-pieced design. Via the shaft, which supports normal braking forces, it is advantageously possible to reduce size and mass compared to a design that includes a brake caliper. The brake caliper is connected to a frame element of the machine tool and/or another element of the machine tool that appears reasonable to a person skilled in the art.

It is furthermore provided that the brake unit includes at least one disk element that is designed to forward the normal braking forces that occur during brake activation to the shaft. Advantageously, the disk element may be designed as a single piece with the shaft and/or a hollow shaft. Advantageously, the disk element is designed as a brake disk. Particularly advantageously, the brake unit may also include two disk elements which include brake elements located between them. In this case, the disk elements are designed as support disks. As an alternative, the brake unit may also be designed as a drum brake. The term “to forward” is intended to mean, in particular, that the disk elements transfer the normal braking forces acting on them to the shaft, which diverts the normal braking forces. As a result, the brake unit may have a simple design, and a brake caliper may be advantageously eliminated.

In a further embodiment, it is provided that the brake unit includes at least one wedge ring. A “wedge ring” is intended to mean, in particular, an annular device which has at least one inclined plane situated in the circumferential direction. Preferably, the inclined plane is designed to act as a wedge actuated brake. Via the use of a wedge ring, a central point of all normal braking forces is advantageously located on a rotational axis of the shaft, thereby reducing stress on components.

In an advantageous embodiment of the present invention, the wedge ring includes at least one fastening element which is designed to be connected to an actuator. Advantageously, the actuator causes a force to be applied to the wedge ring, in an axial direction of the shaft. As an alternative, the actuator causes a force to be applied to the wedge ring, in a tangential direction of the wedge ring. An “actuator” is intended to mean, in particular, a device that applies a force via the fastening element to the wedge ring, thereby causing the wedge ring to move. Kinetic energy may be provided by the actuator itself or by a spring element. A “fastening element” is intended to mean, in particular, an element which is used to connect the actuator to the wedge ring. Using the design, it is advantageously possible to use various actuators.

It is furthermore provided that the wedge ring is axially displaceable. The expression “axially displaceable” is intended to mean, in particular, that the wedge ring may be moved in the direction of the rotational axis, thereby modifying a position of the wedge ring when braking is activated and ensuring that a particularly strong braking effect may be attained.

It is furthermore provided that the wedge ring includes planar surfaces that are designed to orient the wedge ring during operation. A “planar surface” is intended to mean, in particular, a region of the wedge ring that is designed to be used as a reference, during operation, for orienting the wedge ring, preferably relative to another wedge ring. The expression “during operation” is intended to mean, in particular, a period of time during an operating state in which a workpiece may be machined. “To orient” is intended to mean, in particular, to position relative to another element. Using the planar surface, the wedge ring may be reliably positioned during operation.

It is furthermore provided that the brake unit includes at least one spring element that is designed to position the wedge ring during operation. The term “to position” is intended to mean, in particular, that the spring element may exert a force on the wedge ring that displaces the wedge ring into a desired position. Advantageously, the spring element displaces the wedge ring in the axial direction relative to a disk element and/or the spring element, or a further spring element displaces a wedge ring in the circumferential direction relative to another wedge ring. Via the spring element, the wedge ring may be permanently positioned relative to a disk element and/or another wedge ring during operation of the machine tool.

Furthermore, the tool emergency brake device includes at least one bearing element that supports at least one wedge ring on a shaft. The term “bearing element” is intended to mean, in particular, a roller bearing and/or another type of bearing that appears reasonable to a person skilled in the art. Using the bearing, the wedge ring may be reliably positioned relative to the shaft.

Furthermore, the tool emergency brake device includes at least one further wedge ring which is rotatable relative to the other wedge ring for brake activation. Furthermore, a bearing element is advantageous which is designed as a roller bearing and supports the two wedge rings relative to one another. In this context, the expression “rotatable relative to the other wedge ring” is intended to mean, in particular, that one wedge ring may be moved about the rotational axis of the shaft relative to the other wedge ring. “Another wedge ring” refers, in particular, to a further wedge ring. The use of the further wedge ring makes it possible to attain particularly high normal braking forces using a simple design.

In a further embodiment it is provided that the brake unit includes at least one coupling element that couples a disk element of the brake unit to a shaft in an axially displaceable manner. “Couple” is intended to mean, in particular, to connect to one another in a non-rotatable manner. As a result, the braking force may be reliably transferred to the shaft.

It is also provided that the wedge actuated brake includes at least one wedge element which axially displaces a disk element of the brake element during brake activation, and therefore the decoupling device may be advantageously actuated in a component-saving manner using a simple design.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a front view of a tool emergency brake device which includes a wedge brake and a decoupling device,

FIG. 2 shows a top view of the tool emergency brake device in FIG. 1, in a sectional view,

FIG. 3 shows a front view of an alternative tool emergency brake device which includes a wedge ring and a brake release device,

FIG. 4 shows a top view of the tool emergency brake device in FIG. 3,

FIG. 5 shows a partial sectional view of a further alternative tool emergency brake device,

FIG. 6 shows a wedge ring of the tool emergency brake device in FIG. 5, in a perspective view.

### DESCRIPTION OF THE PREFERRED EMBODIMENTS

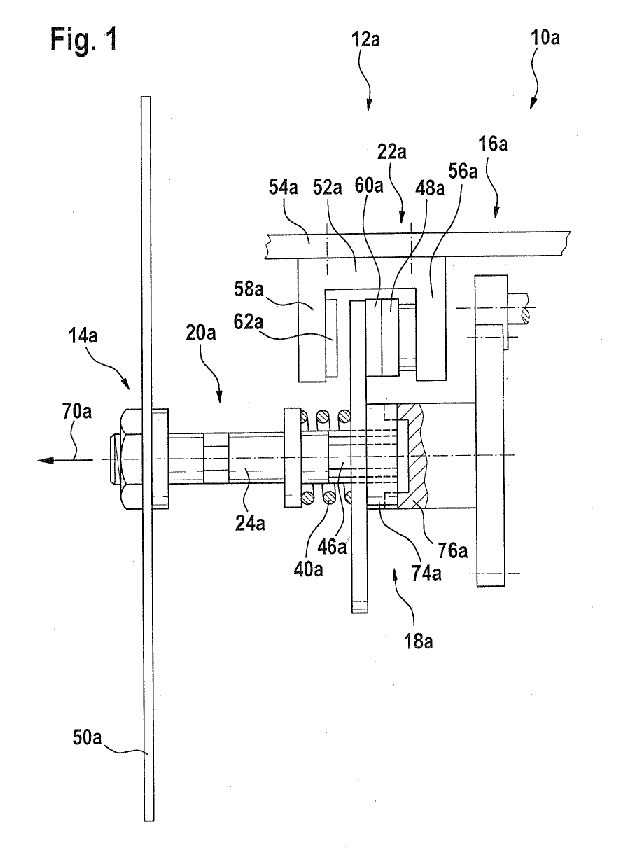

FIG. 1 shows a schematic illustration of a tool emergency brake device 10a. Tool emergency brake device 10a is installed in a machine tool, which is designed as a circular saw and is not shown in greater detail, and it is designed to brake a tool 50a designed as a circular saw blade. For this purpose, tool emergency brake device 10a includes a brake unit 12a which brakes in a self-energizing manner. For this purpose, brake unit 12a includes a disk element 26a designed as a brake disk, a shaft 24a, a wedge actuated brake 22a, and a brake caliper 52a. Brake caliper 52a is designed as a floating caliper. As an alternative, it may be designed as a fixed caliper, or it may have another design that appears reasonable to a person skilled in the art. Brake caliper 52a is located between shaft 24a and a working surface 53a of the machine tool above disk element 26a, and it is fixedly connected to a stable frame element 54a of the machine tool. Frame element 54a diverts friction braking forces that occur during brake activation to a not-shown placement surface of the machine tool. Brake caliper 52a is formed by a U-shaped metal element, and is situated such that disk element 26a, which is non-rotatably connected to shaft 24a and a tool fitting 14a, extends between two legs 56a, 58a of brake caliper 52a.

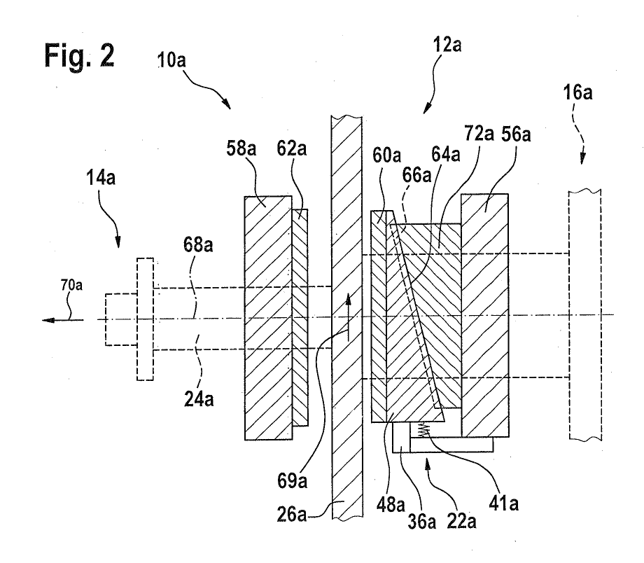

FIG. 2 shows a sectional view of tool emergency brake device 10a at the level of legs 56a, 58a of brake caliper 52a parallel to a rotational axis 68a of shaft 24a, in a view from above. It is shown that wedge actuated brake 22a is located between one of the legs 56a and disk element 26a, and extends perpendicularly to rotational axis 68a of shaft 24a, and parallel to working surface 53a; wedge actuated brake 22a is located on an inner side of each leg 56a that faces a drive unit 16a.

A brake pad 60a, 62a is located on an interior side, which faces disk element 26a, of leg 58a, and on a wedge element 48a which is located on a side of wedge actuated brake 22a or leg 56a that faces disk element 26a. Wedge brake 22a includes a further wedge element 72a which is fixedly connected to brake caliper 52a, and forms an inclined plane 64a. Wedge element 48a is movably situated on inclined plane 64a, and it is connected thereto via a groove 66a. Inclined plane 64a is oriented such that wedge element 48a, which may move on inclined plane 64a, is moved toward disk element 26a in the direction of tool fitting 14a when wedge element 48a moved in rotational direction 69a of disk element 26a. Furthermore, brake unit 12a includes an actuator 36a which moves movable wedge element 48a in rotational direction 69a of disk element 26a during brake activation. In addition, drive unit 16a is designed as a gear stage.

If a not-shown sensor detects the presence of a hazard to an operator due to tool 50a, a not-shown computer unit moves wedge element 48a using actuator 36a on inclined plane 64a in rotational direction 69a of disk element 26a. As a result, wedge element 48a is moved toward disk element 26a. As soon as disk element 26a and brake pad 60a of wedge element 48a touch one another, the frictional braking force between disk element 26a and brake pad 60a accelerate wedge element 48a. Wedge element 48a forces disk element 26a onto a coupling element 46a shown in FIG. 1 in direction 70a of tool fitting 14a. As a result, disk element 26a comes in contact with brake pad 62a which is located on the inner side of leg 58a facing tool fitting 14a. Via the motion of wedge element 48a caused by the frictional braking force on inclined plane 64a, normal braking forces result which further amplify the frictional braking forces of the two brake pads 60a, 62a. Disk element 26a and, therefore, shaft 24a and tool 50a therefore come to a standstill in as very short period of time, i.e., in less than 5 ms in this case.

Furthermore, FIG. 1 shows that brake unit 12a includes a decoupling device 18a which is designed as a claw clutch. Decoupling device 18a decouples tool fitting 14a and drive unit 16a in a driving manner when the emergency brake is activated. To this end, brake unit 12a includes coupling element 46a which is designed as profiled gearing, which non-rotatably couples disk element 26a to shaft 24a in an axially displaceable manner. Movably situated wedge element 48a displaces disk element 26a in axial direction 70a toward tool fitting 14a when braking is activated. A part 74a of decoupling device 18a connected to disk element 26a releases a non-rotatable connection to a part 76a of decoupling device 18a that is non-rotatably connected to drive unit 16a. It is therefore only necessary to brake the rotating mass of disk element 26a, shaft 24a, and tool 50a. A spring element 40a induces a force along rotational axis 68a of shaft 24a opposite to direction 70a of drive unit 16a, thereby positioning or fixing part 74a—which is non-rotatably connected to disk element 26a—of decoupling device 18a to part 76a—which is non-rotatably connected to drive unit 16a—of decoupling device 18a during operation of the machine tool or when brake unit 12a is released.

In addition, brake unit 12a includes a brake release device 20a which is designed as a hexagonal profile and a tool key which is not shown in greater detail. After braking is carried out, brake release device 20a returns brake unit 12a to a ready-to-use state; this is accomplished by the tool key applying a torque, which is directed against rotational direction 69a, to shaft 24a. As a result, wedge element 48a is moved out of the self-inhibiting position, and is moved into a position apart from disk element 26a using tension-loaded spring element 41a (see FIG. 2). The force may be applied by an operator, or it may be generated by a device which is not shown.

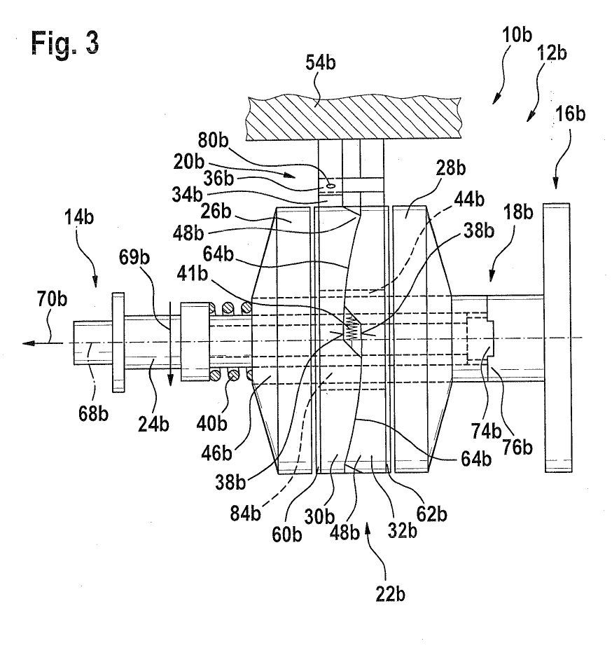

Two further embodiments of the present invention are depicted in FIGS. 3 through 6. To differentiate the embodiments, the letter “a” in the reference numerals used for the embodiment in FIGS. 1 and 2 is replaced with letters “b” and “c” in the reference numerals for the embodiments shown in FIGS. 3 through 6. The description that follows is limited mainly to the differences from the embodiment in FIGS. 1 and 2. With regard for the components, features, and functions that remain the same, reference is made to the description of the embodiment in FIGS. 1 and 2, and 3 and 4.

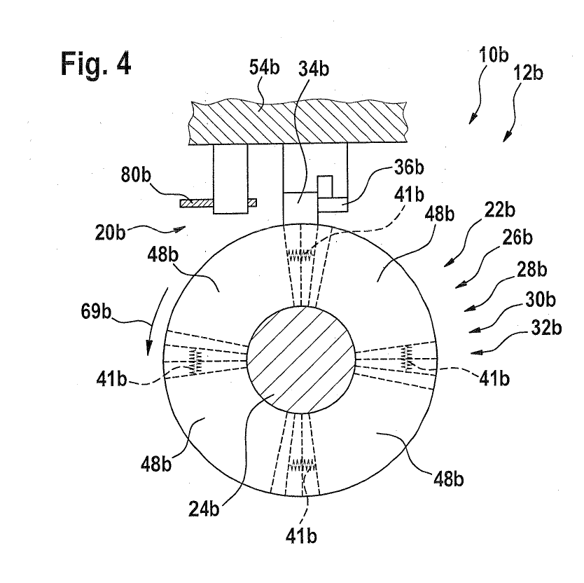

FIGS. 3 and 4 show a tool emergency brake device 10b which includes a brake unit 12b, which is designed as wedge actuated brake 22b, shaft 24b, a hollow shaft 84b, two wedge rings 30b, 32b, an actuator 36b, and two disk elements 26b, 28b designed as support disks. Disk elements 26b, 28b are positioned radially around hollow shaft 84b, and they are non-rotatably connected to hollow shaft 84b; one of the disk elements 26b is designed as a single piece with hollow shaft 84b which connects disk elements 26b. The other disk element 28b is screwed together with hollow shaft 84b in a manner which is not shown. Hollow shaft 84b and shaft 24b are situated coaxial to one another, and they are non-rotatably connected to one another using a coupling element 46b.

Two wedge rings 30b, 32b are also situated radially around shaft 24b, axially between disk elements 26b, 28b. On the sides facing disk elements 26b, 28b, wedge rings 30b, 32b each include a brake pad 60b, 62b. Each wedge ring 30b, 32b includes four wedge elements 48b, each of which includes an inclined plane 64b formed by a flat surface, and a steep surface 78b (see FIG. 6). Wedge rings 30b, 32b are located on lateral surfaces of wedge rings 30b, 32b, and so inclined planes 64b come to rest on top of one another. Between wedge elements 48b, wedge rings 30b, 32b have planar surfaces 38b which orient wedge rings 30b, 32b opposite one another during operation. Planar surfaces 38b are oriented perpendicularly to a rotational axis 68b of shaft 24b. A spring element 41b which positions wedge rings 30b, 32b during operation in such a manner that they are rotatably opposite to one another is located between each of the two steep surfaces 78b of wedge elements 48b.

One of the wedge rings 30b is rotatably supported on shaft 24b and includes a fastening element 34b which is designed to be connected to actuator 36b. The other wedge ring 32b is non-rotatably connected to a stable frame element 54b of the machine tool. Wedge rings 30b, 32b are supported on shaft 24b using a bearing element 44b designed as a roller bearing. Actuator 36b is designed as an electromagnet, and is also connected to frame element 54b.

If a not-shown sensor detects the presence of a hazard to an operator due to the tool, a not-shown computer unit moves rotatable wedge ring 30b using actuator 36b in rotational direction 69b of shafts 24b. Rotatable wedge ring 30b is rotated relative to fixed wedge ring 32b, thereby pressing rotatable wedge ring 30b via inclined planes 64b in direction 70b of tool fitting 14b. If brake pad 60b of rotatable wedge ring 30b touches closest disk element 26b, rotatable wedge ring 30b is accelerated via the frictional braking force in rotational direction 69b of shaft 24b, and disk element 26b located in direction 70b of tool fitting 14b is pressed in direction 70b against spring element 40b. The hollow shaft transfers the motion of disk element 26b to the other disk element 28b which therefore moves toward non-rotatable wedge ring 30b. As soon as brake pads 60b, 62b of the two wedge rings 30b, 32b touch the two disk elements 26b, 28b, normal braking forces result which are transferred from disk elements 26b, 28b to shaft 24b, and are supported by shaft 24b. The normal braking forces cause the frictional braking forces to increase, and they act until shaft 24b and, therefore, tool 50b have stopped.

Brake unit 12b includes a brake release device 20b which is designed as a rack 80b which includes a drive device which is not shown in greater detail and is designed as an electric motor. After braking has been carried out, brake release device 20b returns brake unit 12b to a ready-to-use state. For this purpose, the drive device, which is designed as an electric motor, is fixedly connected to frame element 54b, and after braking is carried out, presses rotatable wedge ring 30b using rack 80b into a position in which wedge ring 30b was located before brake activation. In this position, rotatable wedge ring 30b is positioned by spring elements 40b. As an alternative, it is feasible to reset the brake device by rotating a tool opposite to a working direction of the tool. If tool emergency brake device 10b is designed appropriately, this rotation may also be carried out manually by an operator.

In the embodiment depicted in FIGS. 3 and 4, wedge ring 32b which is non-rotatably connected to frame element 54b is axially fixed and, upon brake activation, displaces disk elements 26b, 28b in direction 70b of a tool fitting 14b. Disk elements 26b, 28b are non-rotatably connected via hollow shaft 84b to coupling element 46b and a part 74b of a decoupling device 18b. A spring element 40b causes a force to be applied to disk elements 26b, 28b along rotational axis 68b of shaft 24b, and thereby positions or fixes part 74b—which is non-rotatably connected to disk elements 26b, 28b—of decoupling device 18b during operation of the machine tool or when brake unit 12b is released. In this position, part 74b—which is non-rotatably connected to shaft 24b and disk elements 26b, 28b—of decoupling device 18b, and part 76b—which is non-rotatably connected to drive unit 16b—of decoupling device 18b are non-rotatably connected to one another.

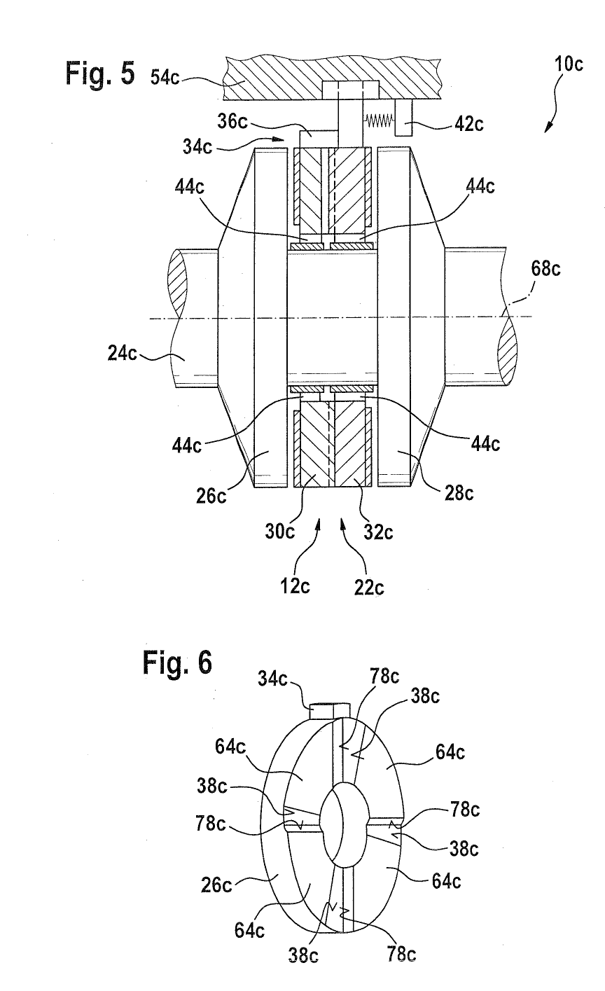

In the embodiment shown in FIG. 5, wedge ring 32c, which is non-rotatably connected to frame element 54c, is axially displaceable. A spring element 42c positions wedge ring 32c during operation in a manner such that wedge rings 30c, 32c are separated by disk elements 26c, 28c. When braking is activated, wedge rings 30c, 32c are axially displaced. Shaft 24c remains axially stable.

FIG. 6 shows a perspective view of a wedge ring 30c which includes a fastening element 34c. Four wedge elements 48c are situated around rotational axis 68c with mirror symmetry, along a circumferential direction. Planar surfaces 38c are located between wedge elements 48c.

It will be understood that each of the elements described above, or two or more together, may also find a useful application in other types of constructions differing from the types described above.

While the invention has been illustrated and described as embodied in the tool emergency brake device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A tool emergency brake device, comprising a brake unit, said brake unit being configured to brake in a self-energizing manner.

2. The tool emergency brake device as defined in claim 1, wherein said brake unit includes a wedge actuated brake.

3. The tool emergency brake device as defined in claim 1, wherein said brake unit includes a shaft which supports normal braking forces which occur during brake activation.

4. The tool emergency brake device as defined in claim 3, wherein said brake unit includes at least one disk element which is configured to forward normal braking forces that occur during brake activation to said shaft.

5. The tool emergency brake device as defined in claim 2, wherein said brake unit includes at least one tapered ring.

6. The tool emergency brake device as defined in claim 5, wherein said tapered ring includes at least one fastening element connected to an actuator.

7. The tool emergency brake device as defined in claim 5, wherein said tapered ring is axially displaceable.

8. The tool emergency brake device as defined in claim 5, wherein said tapered ring includes planar surfaces that are provided to orient said tapered ring during operation.

9. The tool emergency brake device as defined in claim 5, wherein said brake unit includes at least one spring element which is configured to position said tapered ring during operation.

10. The tool emergency brake device as defined in claim 5, further comprising at least one bearing element which supports said at least one tapered ring.

11. The tool emergency brake device as defined in claim 5, further comprising at least one further tapered ring which is rotatable relative to said tapered ring for brake activation.

12. The tool emergency brake device as defined in claim 2, wherein said tapered brake includes at least wedge element which axially displaces at least one disk element of said brake unit during brake activation.

13. A tool emergency brake device, comprising a brake unit; a tool fitting; and a drive unit, wherein said brake unit includes a decoupling device which is configured to decouple said tool fitting and said drive unit in terms of driving action when an emergency brake is activated.

14. The tool emergency brake device as defined in claim 13, wherein said brake unit includes a shaft which supports normal braking forces which occur during brake activation.

15. The tool emergency brake device as defined in claim 14, wherein said brake unit includes at least one disk element which is configured to forward normal braking forces that occur during brake activation to said shaft.

16. The tool emergency brake device as defined in claim 13, wherein said brake unit includes at least one coupling element which couples at least one disk element of said brake unit to a shaft in an axially displaceable manner.

17. A tool emergency brake device, comprising a brake unit, said brake unit including a brake release device which is configured to return said brake unit to a ready-to-use state after braking is carried out.

18. The tool emergency brake device as defined in claim 17, wherein said brake unit includes a shaft which supports normal braking forces which occur during brake activation.

19. The tool emergency brake device as defined in claim 18, wherein said brake unit includes at least one disk element which is configured to forward normal braking forces that occur during brake activation to said shaft.
